(19) United States
(12) Patent Application Publication
(10) Pub. No.: US 2014/0372172 A1
(43) Pub. Date: Dec. 18, 2014

(54) METHOD AND COMPUTER SYSTEM TO FORECAST ECONOMIC TIME SERIES OF A REGION AND COMPUTER PROGRAM THEREOF

(71) Applicant: TELEFONICA DIGITAL ESPANA, S.L.U., Madrid (ES)

(72) Inventors: Vanessa FRÍAS MARTÍNEZ, Madrid (ES); Enrique FRÍAS MARTÍNEZ, Madrid (ES)

(21) Appl. No.: 13/915,733

(22) Filed: Jun. 12, 2013

(51) Int. Cl. G06Q 30/02

(52) U.S. Cl. CPC G06Q 30/0202; G06Q 30/0205
USPC 705/7.31

(57) ABSTRACT

The method uses a computer device to receive as inputs socio-economic data of a region during a definite time period representing an economic time series that are stored in a first database, comprising: computing, during the same definite time period, the average values of each of a plurality of anonym and aggregated call records generated by individuals using a plurality of base stations of said region obtaining calling variables and computing from said calling variables calling variables' time series representing average temporal usage statistics that are stored in a second database; and building from said economic time series and said computed calling variables time series a model to forecast future values of the economic time series of said region.

### FIELD OF THE ART

The present invention generally relates to a method, a computer system and a computer program to forecast economic time series of a region, and more particularly to a method, a computer system and a computer program to improve the forecasting power of auto regressive (AR) time series analysis techniques over socio-economic time series incorporating calling pattern variables computed from anonymized and aggregated call records.

### BACKGROUND OF THE INVENTION

Socio-economic time series measure variables like levels of employment or the gross domestic product (GDP) which provide insightful information regarding the economic status of a region or a country on a daily or monthly basis. Accurately computing these time series is critical given that many policy decisions made by governments are based upon them. For that purpose, National Statistical Institutes (NSIs) typically hire enumerators to gather information concerning such economic indicators.

However, this approach is highly expensive; in fact, governments can spend up to several million dollars on interviews to gather information regarding social indicators. For that reason, NSIs also work with projections or predictions of future values. In order to compute future values, AR time series analysis is typically used where previous values of the socio-economic time series computed through surveys are utilized to predict values in the future years when no surveys are run.

The ubiquitous presence of social media and cell phones is generating large datasets of web searches, tweets or call logs that reveal human behavioral footprints. Data mining techniques applied to such datasets have been used to extract temporal usage patterns correlated to specific economic time series. For example, Google® has developed Google Correlate that analyzes the predictability of different economic indicators [5] such as refinance index or mortgage rates from related web searches. Specifically, it uses different time series techniques to forecast economic trends from web search information. On the other hand, other solutions study the relationship between Twitter® activity and time series from the financial domain [4]. Using features extracted from Twitter® datasets (both activity and graph features) the authors show how these can predict the temporal evolution of the stock market. Activity features refer to volumetric measures of Twitter® activity talking about companies and the stock market including number of tweets or number of hashtags; whereas graph features modeled the properties of the Twitter® graph that is formed when users tweet or re-tweet about stock companies including number of nodes, edges, and number of connected components or degree. These features, modeled over time, generate time series that can be compared against stock market data series to understand the relationship between both. The authors explored how the use of specific Twitter® features could be used to model the evolution of the stock market.

A similar approach was used by Zhang et al. [7] to show the existence of correlations between the sentiment in specific Twitter® posts and stock market indicators and to analyze the predictive power of microblogging logs with respect to specific economic indicators. Using re-tweets (RT@) originating from the US and containing both feeling- and economic-related words—such as hope or dollar—the authors build two time series: the number of re-tweets and the evolution of economic indicators NASDAQ, DJIA or S&P. The authors found statistically significant correlations between tweet statistics and changes in oil price or the DJIA. Additionally, using correlation and Granger's causality analysis the authors posit that Twitter posts might be able to forecast changes in economic indices one day in advance.

There exists a large body of work analyzing the relationship between economic indicators and cell phone calling records [1, 2, 3], however, none focuses on prediction of future values. Blumenstock et al. [1] studied the impact that economic status has on cell phone use in Rwanda. The authors combined two datasets, one containing call detail records from a Telco company in Rwanda and the other one containing economic variables computed from interviews. Their main findings revealed large statistically significant differences across economic levels with higher levels showing larger social networks and larger number of calls among other factors. Similarly, Frias et al. [3] showed that there exist differences between specific economic factors and how cell phones are used by citizens in an emerging economy in Latin America. The authors combined cell phone calling records from an emerging region with economic information collected by the National Statistical Institute of the country through personal interviews and questionnaires. The results showed statistically significant differences between economic levels and the number of calls people make.

Moving beyond statistical relationships, Soto et al. [6] extended the previous research by proposing the use of Support Vector Machines (SVMs) and Random Forests to compute the socioeconomic level of a region based on cell phone usage patterns computed from call logs. The authors' use both call logs and socioeconomic levels from 2010 and divide them into training and testing sets, reporting classification accuracy rates of over 80%. However, it is important to highlight that this approach can only compute present values i.e., determine the socioeconomic level of a region at a moment in time, based on the socioeconomic levels and call logs from other regions at that same moment in time, and not for any time in the future.

The problem with this known solutions is that they forecast socio-economic time series exclusively using previous values of the time series (AR approaches). However, given that many policy decisions are based upon these predictions and given that real values are expensive to compute, this patent focuses on improving the models that forecast such socio-economic time series.

Previous attempts to improve the prediction of social or economic time series have been proposed in the past using Google® or Twitter® datasets [4, 5]. These approaches incorporate search or tweeting patterns of citizens to enhance forecasting models of social or economic time series regarding the regions where they live. Bringing together socio-economic time series and search or tweet data has shown improvements in the forecasting power of the models. However, these approaches have an important drawback: the penetration rates of Google® or Twitter® technologies are not uniform, with larger number of users in developed countries. Thus, using these datasets to predict socio-economic trends might work for countries that hold high penetration rates for these technologies.

### REFERENCES

[1] J. Blumenstock and N. Eagle. Mobile divides: Gender, socioeconomic status, and mobile phone use in rwanda. In ICTD, 2010.
[2] V. Frias-Martinez, J. Virseda, A. Rubio, and E. Frias. Towards large scale technology impact analyses: Automatic residential localization from mobile phone-call data. In ICTD, 2010.
[3] V. Frias-Martinez, J. Virseda, and E. Frias. On the relationship between socio-economic actors and cell phone usage. In ICTD, 2012.
[4] M. Mohebbi, D. Vanderkam, and et. al. Google correlate whitepaper, 2011. www.google.com/trends/correlate/whitepaper.pdf.
[5] E. Ruiz, V. Hristidis, C. Castillo, A. Gionis, and A. Jaimes. Correlating financial time series with micro-blogging data. In WSDM, ACM Press, 2012.
[6] V. Soto, V. Frias-Martinez, J. Virseda, and E. Frias. Prediction of socioeconomic levels using cell phone records. In User Modelling, Adaptation and Personalization, 2011.
[7] X. Zhang, H. Fuehre, and P. Gloor. Predicting asset value through twitter buzz. In Collective Intelligence, 2011.

### SUMMARY OF THE INVENTION

It is therefore an object of the present invention to provide a method, a computer system and a computer program that enhance the previous forecasting techniques making use of the information extracted from cellular networks to predict future values of economic time series, by characterizing cell phone usage of a region as a set of variables' time series that represent average temporal usage statistics for the citizens that live within that region.

Additionally, the invention can be run in an affordable manner due to data is already being gathered by telecommunication companies and as many times as needed since the calling variables can be computed and re-computed at any time (data is available on a daily basis).

The invention is applicable to any region/country with cell phone penetration rates that might be representative of the population at large.

According to a first aspect of the present invention, it is provided a method to forecast economic time series of a region comprising using a computer device, including a processor for executing instructions, to receive as inputs socio-economic data of a region, preferably provided by National Statistical Institutes (NSI), during a definite time period, (i.e. monthly, weekly, daily) representing an economic time series that are stored in a first database, wherein the method comprises: computing, during the same definite time period, the average values of each of a plurality of anonym and aggregated call records generated by individuals using a plurality of base stations of said region obtaining calling variables; computing from said calling variables, calling variables' time series representing average temporal usage statistics that are stored in a second database; and building from said economic time series and said computed calling variables' time series a model to forecast future values of the economic time series of said region.

So, the method can be described as having or as consisting in two different steps: A calibration phase where all the forecasting model parameters' are computed and a prediction phase where the forecasted values of a given economic time series in the future are outputted. In the calibration phase, is also selected the forecasting model that better predicts the training samples available during the calibration phase. This phase can be re-run any time new samples of any economic time series or calling variables calling variable time series are obtained.

According to a preferred embodiment, the built model comprises a vector auto regressive (VAR) model.

The calling variables are variables that model the calling patterns of the individuals where the economic time series are measured being obtained from the call records for each unit of time and by each individual. The invention, as a preferred option, proposes to use two different groups of these calling variables: consumption and mobility variables. The consumption variables, for instance, can measure the average number of input or output calls (IC, OC) and/or the average length of the same calls for said individual within said particular region in a given time period. On another hand, the mobility variables can measure an average distance that said individuals travel while talking (TDIST) or between calls (RDIST).

The calling variables' time series represent the time series values for each calling variable over time (a value per unit of time, for instance each month).

According to an embodiment, said model to forecast futures values of the economic time series of said region is further trained and calibrated. In order to do that, preferably, all calling variable time series are fetched and the n points in each time series are divided into a training set; then, for each individual economic time series, the set of training time series are tested, by means of a testing set, in order to calibrate values p and q in VAR (p,q) model; and finally the calibrated p and q values with the best R-square value are selected.

For instance, the training and testing sets can comprise, respectively, 60% and 40% of its points maintaining the temporal order.

According to a second aspect of the present invention, it is provided a computer system to forecast economic time series of a region, comprising:
a receiver that, using a processor of a computer device, receives as inputs socio-economic data of a region during a definite time period representing economic time series that are stored in a first database;
a calibrator that, using said processor, computes, during the same definite time period, the average values of each of a plurality of anonym and aggregated call records generated by individuals using a plurality of base stations of said region obtaining calling variables and to compute from said calling variables, calling variables' time series representing average temporal usage statistics that are stored in a second database; and
a predictor that, using said processor, builds from said economic time series and said computed calling variables' time series a model to forecast future values of the economic time series of said region,
   wherein the computer system of the second aspect implements the method of the first aspect.

According to third aspect of the present invention, it is provided a non-transitory computer readable medium storing a program causing a computer to execute a method to forecast economic time series of a region, comprising software code configured for building when running on a computer a model to forecast future values of the economic time series of said region by using economic time series concerning socio-economic data of the region during a definite time period and calling variables' time series computed from calling variables obtained from anonym and aggregated call records generated by individuals using a plurality of base stations of said region.

The present invention improves current approaches to predict economic time series and economic changes before these actually happen and saving the budget necessary to compute these values. Moreover is useful across geographic regions because it uses calling data that is available throughout developed and emerging countries, unlike other approaches that use data which is very limited in certain regions.

The forecasting power (i.e. accuracy) of models that exclusively use socio-economic time series data (i.e. AR models) is improved between 5% and 65% when compared to the proposed forecasting model that incorporate calling time series.

### BRIEF DESCRIPTION OF THE DRAWINGS

The previous and other advantages and features will be more fully understood from the following detailed description of embodiments, with reference to the attached, which must be considered in an illustrative and non-limiting manner, in which:

FIG. 1 is an example of the call records used in the present invention.

FIG. 2 is a flowchart illustrating an example of the first step of the calibration phase proposed in the present invention according to an embodiment.

FIG. 3 is a flowchart illustrating an example of the second step of the calibration phase proposed in the present invention according to an embodiment.

FIG. 4 is a flowchart illustrating an example of the prediction phase proposed in the present invention according to an embodiment.

### DETAILED DESCRIPTION OF SEVERAL EMBODIMENTS

In reference to FIG. 2 it is showed how the first step of the calibration phase is calculated, according to an embodiment of the present invention. This calibration phase uses the anonymized and aggregated call records (from now on termed as CDRs) of the individuals or subscribers that live in the region where the economic time series are measured as well as one or various economic time series modeling different economic variables for the same geographical region.

In said first step of the calibration phase, first the calling variables' time series are computed across all individuals for each calling variable with the same temporal granularity t as the economic NSI series, i.e. if the economic time series measures a variable on a daily basis (t=day), the calling variables are modeled daily. Similarly, if the economic time series measures a variable on a monthly basis (t=month), the calling variables should also be measured monthly. After retrieving the temporal granularity 1A, for each calling variable C, a time series C={C0, C1, . . . , Cn} is computed where each Cᵢ represents the average value of calling variable C for temporal granularity i (day or month i) 1B. The average is computed over all existing CDRs and represents the average value for the population at large. This step computes the time series for the following calling variables:
consumption variables: the number of input and output calls (IC, OC) and the duration of the calls (both input and output) for all the CDRs stored in the call detail records database DB3 and for each temporal granularity t are measured.
   IC={IC₀, IC₁, . . . , ICₙ} where IC represents the time series for the average number of input calls for all individuals in the region under study. Each ICᵢ represents the average number of input calls during temporal granularity i (being i a day, a month, same temporal granularity as the economic time series).
   Similarly, OC={OC₀, OC₁, . . . , OCₙ} represents the time series for average number of output calls; average input duration ID={ID₀, ID₁, . . . , IDₙ} and average output duration OD={OD₀, OD₁, . . . , ODₙ}.
   mobility variables: the average distances that individuals travel while talking (Talk Distance TDIST) or between calls (Route Distance RDIST) are measured. Every time a call is placed or received, the CDR generated contains the latitude and longitude of the base station or BTS where the call started and ended. From these data, the average distance that the individuals travelled during each call (TDIST) or the average distance individuals' travel between calls (RDIST) can be computed.
   Time Series TDIST={TDIST₀, TDIST₁, . . . , TDISTₙ} where each TDISTₜ is computed as

$${TDIST}_{t} = \frac{{\sum }_{i = 0}^{n} {TDIST}_{i}}{n}$$

where n represents the total number of individuals and TDIST the talking distance per individual. Similar time series is computed for RDIST.
Time Series RGYR={RGYR₀, RGYR₁, . . . , RGYRₙ} where each RGYRₜ is computed as

$${RGYR}_{t} = \frac{{\sum }_{i = 0}^{n} {\sum }_{j = 0}^{m} {DIST}_{i} ( {w}_{j} * {BTS}_{j} )}{n}$$

where n represents the total number of individuals, m the total number of BTSs visited by an individual and DISTᵢ the Euclidean distance between the BTSs weighted by the number of times the BTS has been used. Similarly, time series DIA is computed as DIA={DIA₀, DIA₁, . . . , DIAₙ} where

$${DIA}_{t} = \frac{{\sum }_{i = 0}^{n} {\sum }_{j = 0}^{m} {DIST}_{i} ( {BTS}_{j} )}{n}$$

and n represents the total number of individuals, m the total number of BTSs visited by an individual and DISTᵢ the Euclidean distance between the BTSs used.

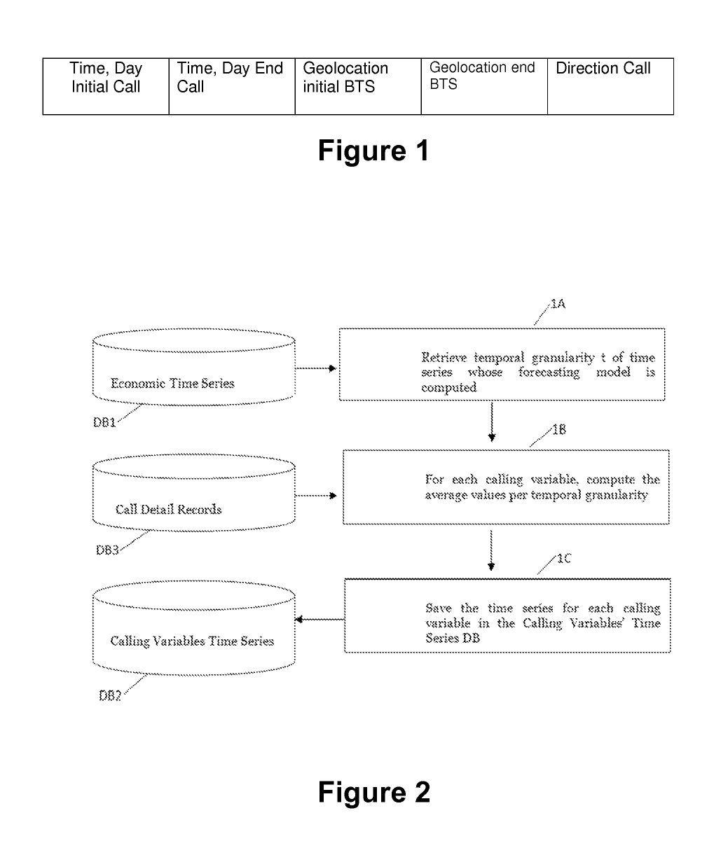

Once all calling variables' time series have been computed, these are saved 1C in a second database DB2. FIG. 1 contains details about individual call records used by the present invention. Mainly, these details would determine the location, time and duration of each individual call.

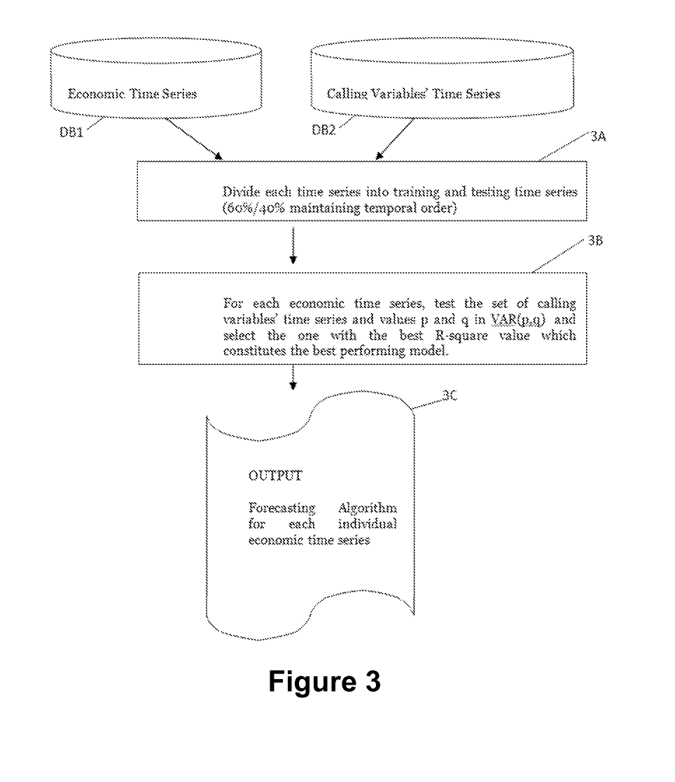

In reference to FIG. 3 how the second step of the calibration phase is calculated, according to an embodiment of the present invention. In this case, for each economic time series stored in a first database DB1, all the consumption and mobility time series variables are retrieved from DB2 and the forecasting model is trained and calibrated. FIG. 3 shows the followed steps. First, the method fetches all calling time series and divides the n points in each time series into a training and a testing set 3A containing, for instance, 60% and 40% of its points respectively i.e., the invention computes a set of training time series where each time series C={C₀, C₁, . . . , Cᵢ} contains i consecutive, temporary ordered elements with i=0.6n and a set of testing time series where each one is represented as C={Cᵢ₊₁, Cᵢ₊₂, . . . , Cₙ} containing 0.4n elements in total 3A.

Next, the training time series are used for the calling variables' time series and the economic time series to calibrate a VAR (Vector Autoregression) model and its p and q parameters 3B. The calibration tests different combinations of calling time series and parameters p and q. For example, a VAR (p=2, q=0) looks like:

y_{1,t}=c₁+τ₁₁¹y_{1,t . . . 1}+τ₁₂¹y_{2,t . . . 1}+τ₁₁²y_{1,t . . . 2}+τ₁₂²y_{2,t . . . 2}+ε₁ₜ

where y₁ represents the economic time series and y₂ one calling variable time series. Such a forecasting model obtains best results with only one calling variable and the economic time series using its values from two units of time in the past. A similar VAR model is computed for each individual economic time series in the first database DB1.

Preferably, each model is evaluated through its R-square value which measures how well the model forecasts the testing set. The forecasting model with the best R-square value is selected 3C. The process is then preferably repeated for each economic time series.

Once the calibration phase has computed the forecasting model parameters', the prediction phase outputs the forecasted parameters or values of a given economic time series in the future. The proposed method can predict the future value of an economic time series at different horizons or time units in the future starting with forecasted values at t=n+1 (horizon 1), t=n+2 (horizon 2), etc. where n is the number of samples used during the calibration phase. For that purpose, it uses both previous economic time series values and previous calling variables' time series values.

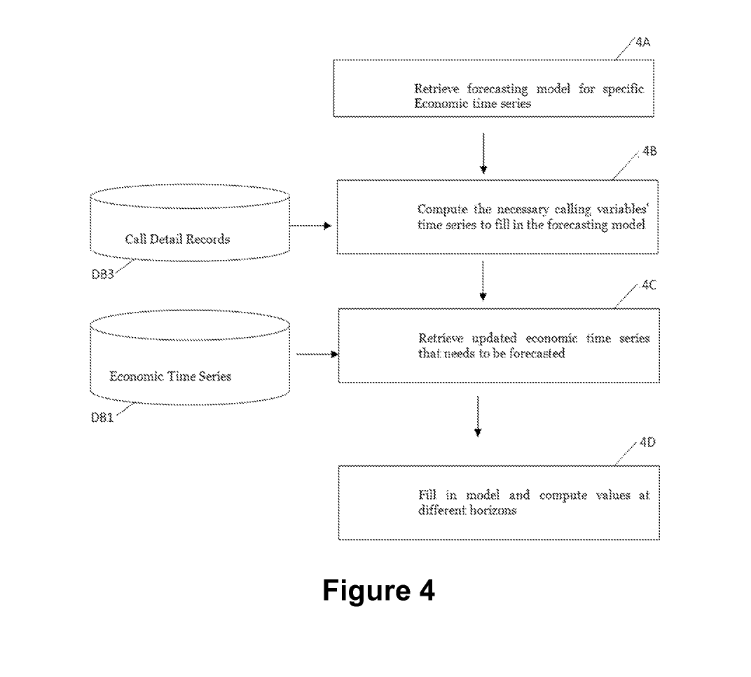

FIG. 4 shows details about this prediction phase. Specifically, every time an individual wants to obtain the forecasted values, the invention will fetch the best forecasting model selected during the calibration phase 4A, retrieve CDRs from the call detail records database DB3 and compute the calling variables' time series for each variable present in the forecasting model 4B, then, retrieve the economic time series values of the series whose values need to be predicted 4C, and compute the forecasting model with the time series values and output predicted values at different horizons or time units 4D.

As a particular example where the present invention can be useful, Table 1 shows the R-square training and testing values for a simple AR model traditionally used by a National Statistical Institute. In this particular case, the invention uses datasets containing time series data regarding employment rates, number of workers, number of civil servants, number of subcontracted workers and number of subcontracted civil servants. With that information in hand, the invention trains and tests the forecasting power (via R-square) of AR models that exclusively use previous values from a given variable to forecast future values. It can be observed that only employment rate, number of subcontracted workers and number of subcontracted civil servants can be forecasted at horizons one and two with R-square values between 0.23 and 0.52.

On the other hand, Table 2 shows the R-square values when the AR model has been enhanced using calling variables extracted from anonymized and aggregated CDRs. Specifically, the new VAR model now contains mobility and consumption variables regarding users that live within the area where the economic time series were collected. It can be observed that such an enhanced model shows improved R-square values between 5% and 65% at horizons one and two for the same set of variables. As shown, the model presented in this patent improves the simple AR approach.

Specifically, it can also be observed for that a traditional AR model that exclusively uses previous values of unemployment rates in the past, can forecast future values with R-square of 0.23 at horizon two (no forecasting for horizon one), whereas the proposed model can forecast at horizon one with an R-square of 0.63 and at horizon two with R-square of 0.31. Similarly, the number of subcontracted workers shows R-square values of 0.52 and 0.07 for horizons one and two, whereas the proposed model boosts these values up to 0.66 and 0.37 respectively. Finally, the proposed model also enhances the forecasting power of the AR model when predicting the number of subcontracted civil servants from 0.3 to 0.35 at horizon two, and provides a 0.51 R-square value for horizon one, which is not possible to forecast using a traditional AR approach.

To sum up, this results show that the proposed VAR model enhanced with calling variables has the ability to improve forecasting results when compared to exclusively using previous data from the time series itself.

TABLE 1

| | Assets | Employment | Workers | C. Servants | Sub. Workers | Sub C. Servants |
|---|---|---|---|---|---|---|
| R-square Train | 0.19 | 0.45 | 0.75 | 0.08 | 0.32 | 0.40 |
| R-square Test (h = 1) | — | — | — | — | 0.32 | — |
| R-square Test (h = 2) | — | 0.23 | — | — | 0.07 | 0.30 |

TABLE 2

| R-square | CDR Series | Assets | Employment | Workers | C. Servants | Sub. Workers | Sub C. Servants |
|---|---|---|---|---|---|---|---|
| Train | 1 | 0.6421 | 0.8262 | 0.5522 | 0.7222 | 0.7448 | 0.6270 |
| | 2 | 0.6140 | 0.8173 | 0.5471 | 0.7226 | 0.7438 | 0.6155 |
| | 3 | 0.6055 | 0.8169 | 0.4889 | 0.6806 | 0.7019 | 0.4781 |
| Test (h = 1) | 1 | — | 0.65 | — | — | 0.53 | 0.51 |
| | 2 | — | 0.18 | — | — | 0.40 | 0.42 |
| | 3 | — | 0.10 | — | — | 0.66 | 0.38 |
| Test (h = 2) | 1 | — | 0.81 | — | — | 0.87 | 0.35 |
| | 2 | — | — | — | — | — | — |
| | 3 | | — | — | — | — | — |

While this invention has been described in connection with what is presently considered to be the most practical and preferred embodiments, it is to be understood that other modifications, additions, and substitutions thereof may be made without departing from the scope of the invention.

1. A method to forecast economic time series of a region, the method comprising using a computer device to receive as inputs socio-economic data of a region during a definite time period representing an economic time series that are stored in a first database, wherein the method comprising:
computing, during the same definite time period, the average values of each of a plurality of anonym and aggregated call records generated by individuals using a plurality of base stations of said region obtaining calling variables and computing from said calling variables calling variable time series representing average temporal usage statistics that are stored in a second database; and
building from said economic time series and said computed calling variables time series a model to forecast future values of the economic time series of said region.

2. A method according to claim 1, wherein said built model comprises a vector auto regressive (VAR) model.

3. A method according to claim 1, wherein said calling variables time series are computed for each one of said calling variables.

4. A method according to claim 3, wherein said calling variables comprises a consumption component and/or mobility component providing consumption variables and/or mobility variables.

5. A method according to claim 4, wherein said consumption component comprises a number of input and output calls (IC, OC) and/or a duration of the calls for all of the computed anonym and aggregated call records.

6. A method according to claim 4, wherein said mobility component comprises an average distance that said individuals travel while talking (TDIST) or between calls (RDIST).

7. A method according to claim 1, wherein said model to forecast futures values of the economic time series of said region is further trained and calibrated by:
fetching all calling variables time series and dividing the n points in each time series into a training set;
for each individual economic time series, testing, into a testing set, the set of training time series to calibrate values p and q in VAR (p,q) model; and
selecting the calibrated p and q values with the best R-square value.

8. A method according to claim 7, wherein said training set and said testing set comprises, respectively, 60% and 40% of its points maintaining temporal order.

9. A method according to claim 1, wherein said model to forecast future values of the economic time series of said region comprises predicting future values in different time units.

10. A method according to claim 1, wherein said socio-economic data is collected by information provided by National Statistical Institutes (NSI).

11. A method according to claim 1, wherein said time period comprises at least a monthly time period, a weekly time period and/or a daily time period.

12. A computer system to forecast economic time series of a region, comprising:
a receiver that, using a processor, receives as inputs socio-economic data of a region during a definite time period representing economic time series that are stored in a first database DB1;
a calibrator that, using said processor, computes during the same definite time period, the average values of each of a plurality of anonym and aggregated call records generated by individuals using a plurality of base stations of said region obtaining calling variables and to compute from said calling variables calling variable time series representing average temporal usage statistics that are stored in a second database DB2; and
a predictor that, using said processor, builds from said economic time series and said computed calling variable time series a model to forecast future values of the economic time series of said region.

13. A non-transitory computer readable medium storing a program causing a computer device to execute a method to forecast economic time series of a region, comprising software code configured for building when running on a computer device a model to forecast future values of the economic time series of said region by using economic time series concerning socio-economic data of the region during a definite time period and calling variable time series computed from calling variables obtained from anonym and aggregated call records generated by individuals using a plurality of base stations of said region.
